(19) United States
(12) Patent Application Publication
(10) Pub. No.: US 2013/0115394 A1
(43) Pub. Date: May 9, 2013

(54) HEAT SHIELD DEVICES

(71) Applicant: Jimmy C. Rich, Peoria, AZ (US)

(72) Inventor: Jimmy C. Rich, Peoria, AZ (US)

(21) Appl. No.: 13/290,350

(22) Filed: Nov. 7, 2011

(51) Int. Cl. B32B 1/08

(52) U.S. Cl. 428/35.2

(57) ABSTRACT

A heat shield device including at least one layer of light/heat reflective material.

### FIELD

The subject technology generally relates to heat shield devices.

### BACKGROUND

For many people living across the United States, heat from the sun, and especially summertime heat, can cause problems, both in terms of accumulated heat and damage caused by ultraviolet radiation. The temperature inside of a parked vehicle can rise dramatically within a few minutes. The dashboard, steering wheel, or seats of a car can reach temperatures hot enough for cooking when not protected. Temperatures in a parked car can easily reach greater than 180 degrees, especially in locations such as Phoenix, Ariz. or other southern areas.

### SUMMARY

The subject technology overcomes the previous problems by providing heat shields that reflect heat-inducing sunlight. Individual embodiments of the instant invention may include all of the elements of the claims and written description as provided herein, or a portion or portions of the element(s) of the claims and written description as provided herein.

In accordance with the subject technology, a heat shield is provided with a first layer, a second layer, an edging, and a pouch. The first layer comprises a sunlight reflective material and the second layer comprises a cushioning material. The edging has a tensile strength that is greater than a combined tensile strength of the first and second layers. The first layer and the second layer are folded at one end to form a pouch.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof, as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology. The features and nature of the present disclosure will become more apparent from the detailed description set forth below when taken in conjunction with the drawings in which like reference characters identify correspondingly throughout and wherein:

FIG. 1 is an illustration of an exemplary heat shield device 4.

FIG. 2 is a side view of an exemplary heat shield device.

FIG. 3 is illustration that shows rays of sunlight 12 striking a steering wheel 13.

FIG. 4 is an illustration showing a manner or method of use of an exemplary heat shield device 16 with a deck chair, lawn furniture, patio furniture, or the like.

FIG. 5 is an illustration showing a manner or method of use of an exemplary heat shield device 25 with a seat of an automobile, airplane, or other vehicle.

FIG. 6 is an illustration of an exemplary heat shield device showing a manner or method of use with the steering wheel of an automobile, airplane, or other vehicle.

FIG. 7 is a side view illustration of an exemplary heat shield device showing a manner or method of use with the steering wheel of an automobile, airplane, or other vehicle.

FIG. 8 is an illustration of an exemplary heat shield device showing a manner or method of use with the steering wheel of an automobile, airplane, or other vehicle.

### DETAILED DESCRIPTION

In the following detailed description, numerous specific details are set forth to provide a full understanding of the subject technology. It will be obvious, however, to one ordinarily skilled in the art that the subject technology may be practiced without some of these specific details. In other instances, well-known structures and techniques have not been shown in detail so as not to obscure the subject technology.

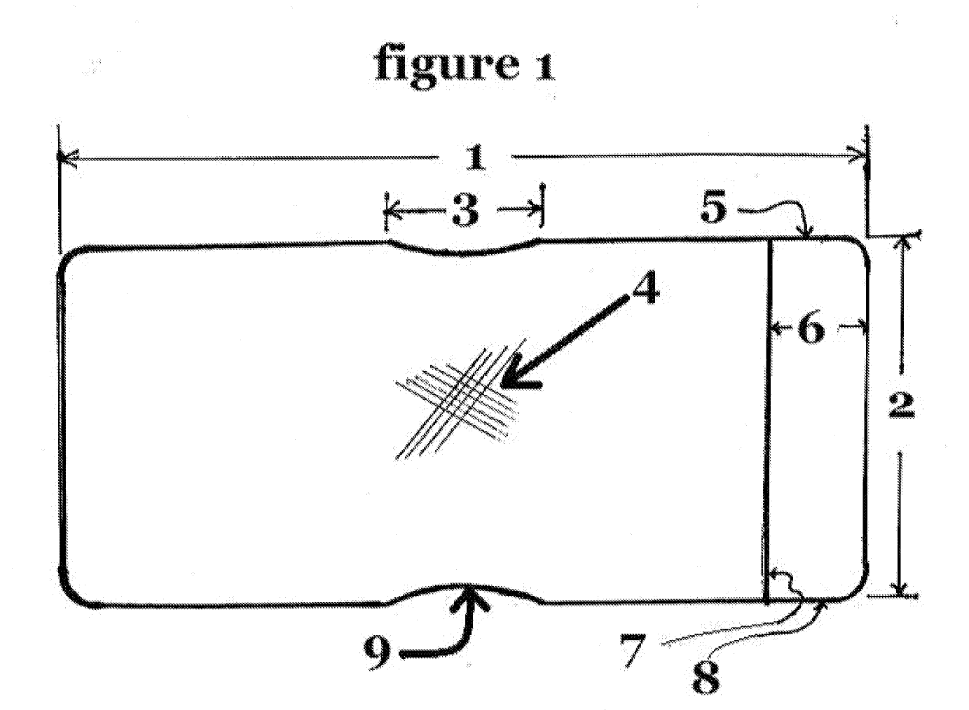

FIG. 1 is an illustration of an exemplary heat shield device 4. Device 4 includes a length 1 and a width 2. In an exemplary embodiment, length 1 is substantially 56 inches, and width 2 is substantially 21 inches. Device 4 may include concave area 9. Concave area 9 includes length 3. Length 3 may be substantially 10 inches in length. Concave area 9 may be an inch or more in concave depth in relation to the area of length 1 not comprising concave area 9. Concave area 9 may denote a folding point between an upper one-half of the device 4 and a lower one-half of the device, or that point where an upper portion covers the up-right portion of a seat and where a bottom portion covers seat portion of a seat.

Device 4 may include a pouch 5. Pouch 5 may also be described as a head portion, a top portion of device 4, or may be described as a pocket. Pouch 5 includes a depth 6. In an exemplary embodiment, depth 6 is substantially 10 inches from an open side 7 of the pouch 5 to a closed side of the pouch on an opposite side of pouch 5 from open side 7.

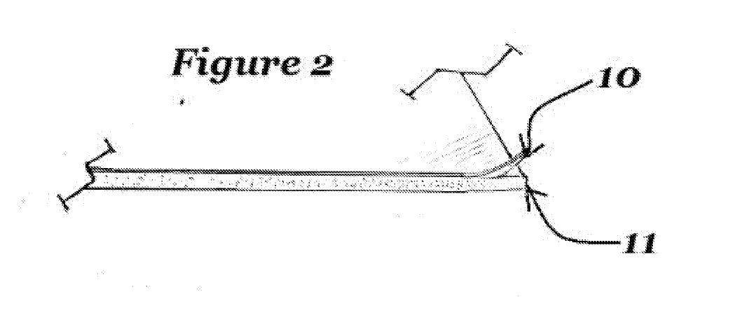

Device 4, in certain embodiments, may comprise flexible edging 8. Flexible edging 8 may be bias tape, canvas or other cloth, plastic, and may include a malleable portion such as a strip or wire of metal, for instance a copper strip or wire that is malleable with the human hand, and that is shape retaining In certain embodiments, flexible edging 8 possesses a tensile strength that is greater than a combined tensile strength of the material that otherwise comprises device 4, for example, layers 10 and 11 as depicted in FIG. 2.

FIG. 2 is a side view of an exemplary heat shield device comprising a first layer 10 and a second layer 11. As shown in FIG. 2, first layer 10 is layered atop second layer 11. First layer 10, in certain embodiments, comprises a flexible, sunlight reflective material with at least one edge, for instance microfoil, mylar, aluminum-coated plastic, cardboard, or cloth, or other sunlight reflective material. Second layer 11, in certain embodiments, comprises a flexible cushioning material, for example foam, bubble wrap, rubber, or cloth.

In certain embodiments, layer 10 may be attached to layer 11 using glue. Layer 10 may also be attached to layer 11 with stitching along a circumference of device 4, for instance at that location where flexible edging 8 is attached to device 4. Flexible edging 8 may be glued, stitched and/or compression fitted to device 4.

Layer 10, in certain embodiments, comprises a reflective material that reflects visible light and/or that reflects light with a wavelength of substantially between 10 nanometers and 400 nanometers. Layer 11, in certain embodiments, comprises a flexible, non-slip material, for instance a rubber gripping material that generally establishes friction against an application surface, e.g., a dashboard, steering wheel, automobile seat, or patio furniture.

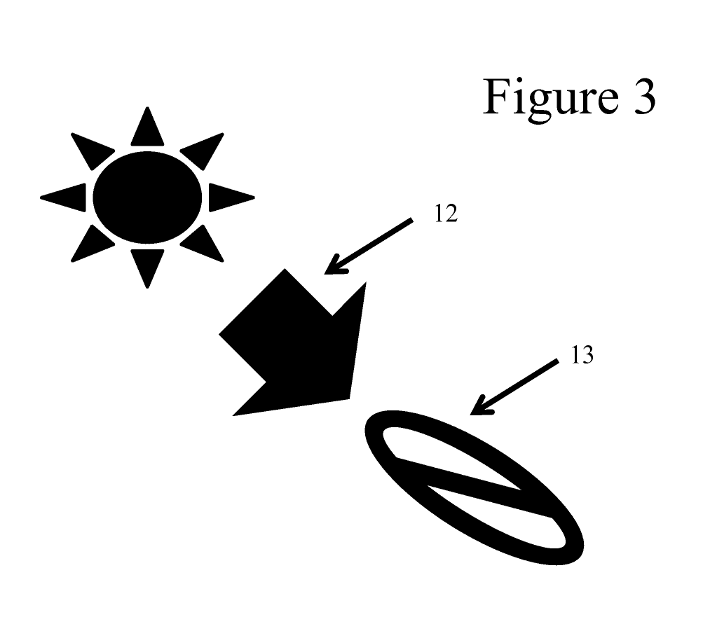

FIG. 3 is an illustration of a steering wheel 13 where rays of sunlight 12 are allowed to strike the steering wheel 13, causing steering wheel 13 to become hot and/or to suffer damage from exposure to the ultraviolet light contained within sunlight 12. Steering wheel 13 may be for an automobile, a boat, a plane, or other vehicle. Drivers who might get into such a vehicle and touch steering wheel 13, could be burned. Further, one problem with cardboard, fold-out accordion style windshield shades is that such shades to not cover the entire windshield, or all windows, allowing sunlight to strike the steering wheel during various parts of the day.

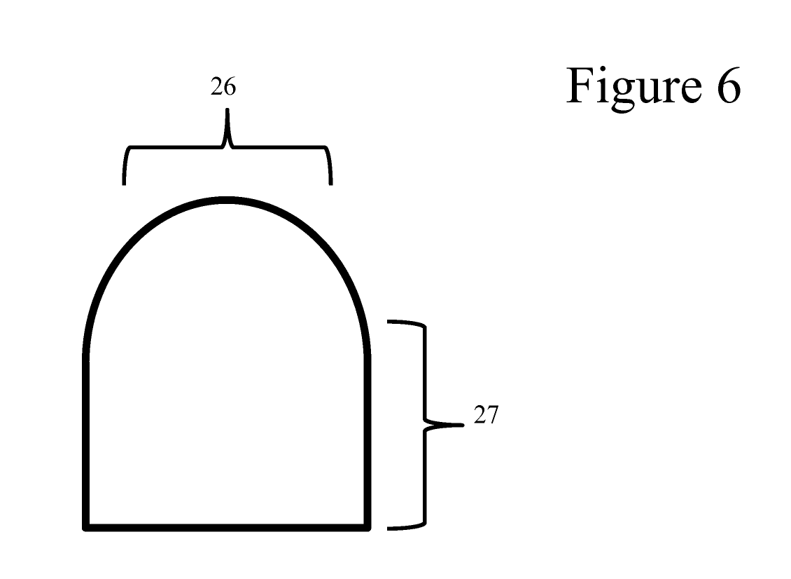

FIGS. 6, 7 and 8, illustrate an embodiment of the instant invention that overcomes the previous problem. FIG. 6 illustrates a heat shield with a width 26 and a length 27 of at least one layer of light/heat reflecting material. In certain embodiments, width 26 comprises a distance slightly longer than the diameter of an average-sized automobile steering wheel, for instance the steering wheel 13 shown in FIG. 3. In additional embodiments, width 26 comprises a distance slightly longer than the distance between the yokes of an airplane or other steering wheel. Length 27 comprises at least the diameter of an average-sized automobile steering wheel, and in some embodiments may be longer or shorter than a diameter of an average-sized automobile steering wheel.

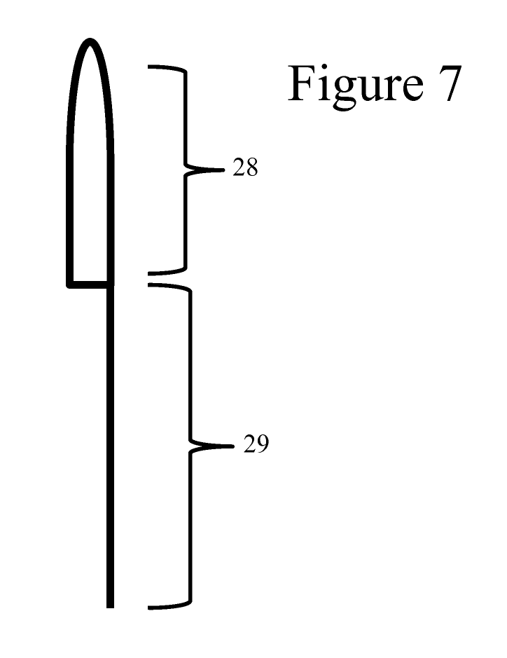

FIG. 7 illustrates a side-view of a heat shield device with pouch 28 and length 29 of at least one layer of light/heat reflecting material. Pouch 28 allows for the device to rest over the top of a steering wheel or other item to be protected from at least one of heat and ultraviolet radiation from sunlight. In certain embodiments, length 29 is of a length sufficient to cover an average-sized automobile steering wheel with the heat shield resting over the top of the steering wheel, and with the top of the steering wheel inserted within pouch 28.

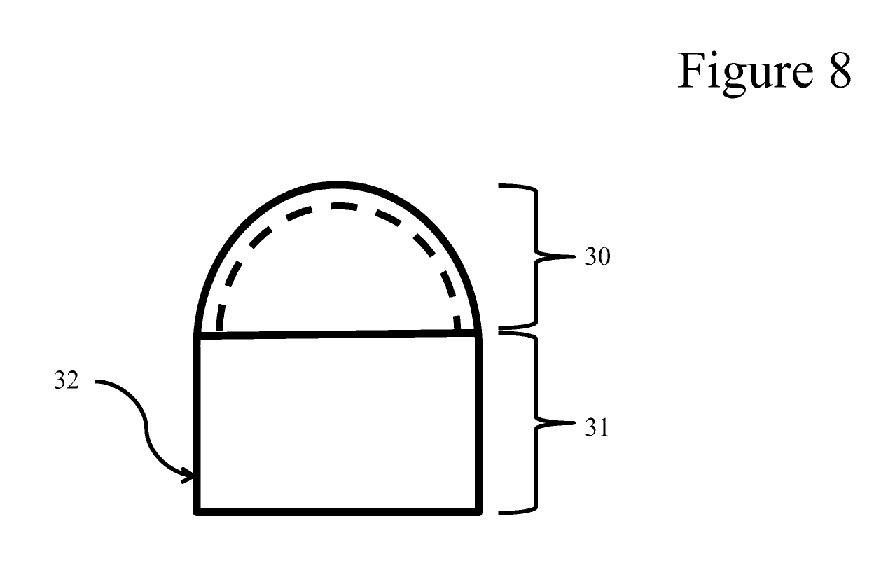

FIG. 8 illustrates an embodiment of the instant heat shield device with a top pouch 30 and a length 31 of light reflecting, and a flexible edging 32. Top pouch 30 is large enough to rest upon the top of an average-sized steering wheel, thereby allowing length 31 to cover the bottom portion of a steering wheel, aircraft yoke, or other item to be protected from at least one of heat and ultraviolet radiation from sunlight. Flexible edging 32 may be bias tape, canvas or other cloth, plastic, and may include a malleable portion such as a strip or wire of metal, for instance a copper strip or wire that is malleable with the human hand, and that is shape retaining In certain embodiments, flexible edging 32 possesses a tensile strength that is greater than a combined tensile strength of the material that otherwise comprises pouch 30 and length 31.

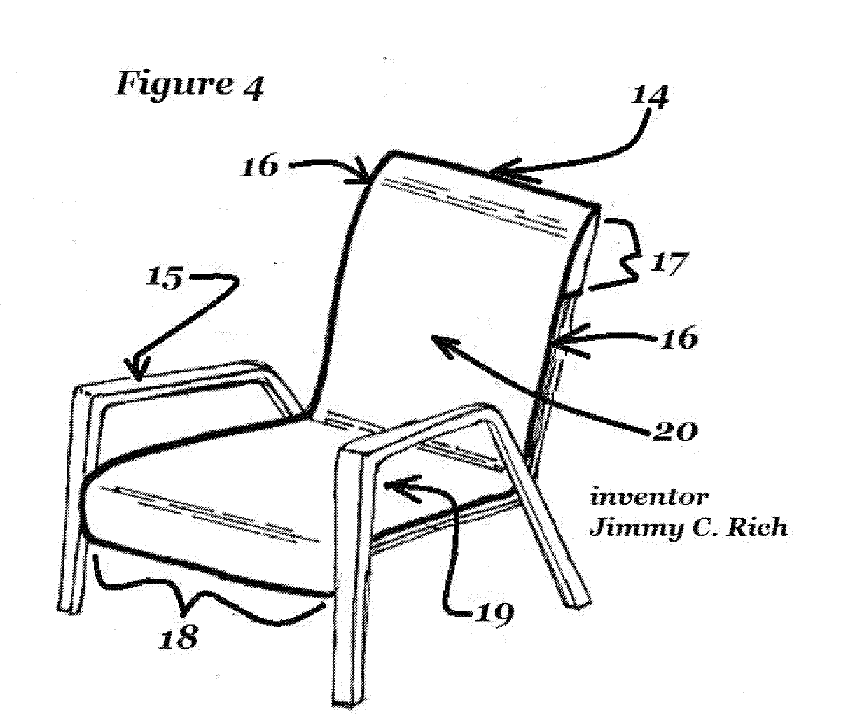

FIG. 4 illustrates a heat shield device 16 in an embodiment of the present invention for use with a deck chair, patio chair, or for other items or furniture. FIG. 4 includes chair 15, and heat shield device 16 includes a top portion 14, pouch 17, a bottom portion 18, a seating portion 19, and a back portion 20. As shown in FIG. 4, pouch 17 allows the heat shield device 16 to rest upon the chair 15 with the top portion 14 resting over the top of chair 15. Back portion 20 rests against the back portion of chair 15, and seating portion 19 rests against the seat of chair 15. Bottom portion 18 may include weights to secure the heat shield device to chair 15 by virtue of gravity. Bottom portion 18, seating portion 19, back portion 20, top portion 14, and/or pouch 17 may include any of magnets, elastic, velcro, grommets, or other securing implementations useful for attaching the heat shield device 16 to chair 15. Heat shield device 16 may include a flexible edging as previously discussed in relation to FIGS. 1-3 and 6-8.

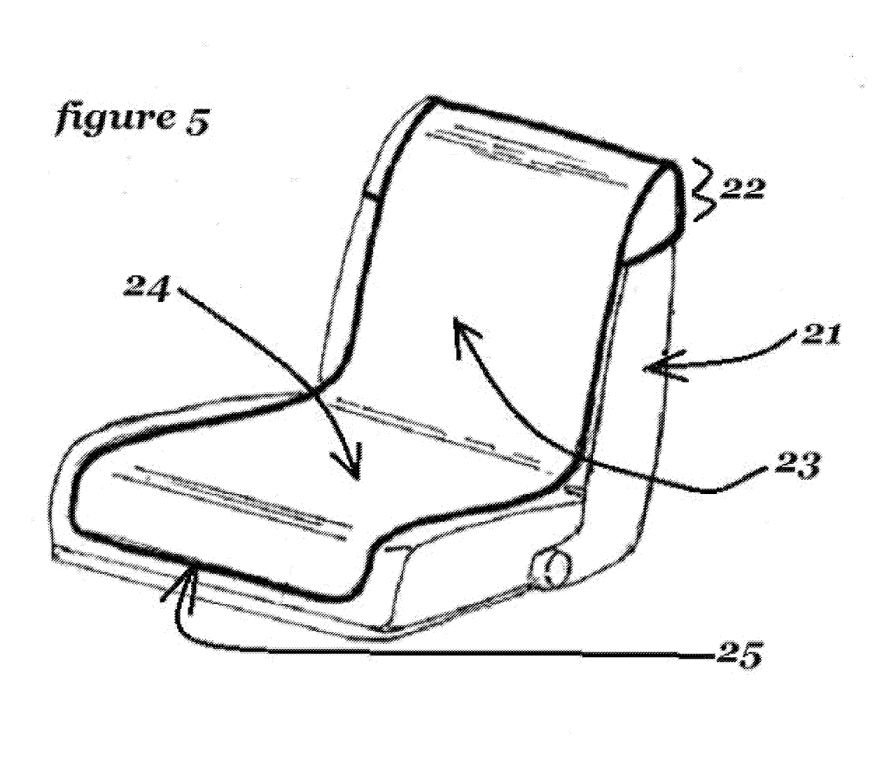

FIG. 5 illustrates a heat shield device 25 in an embodiment of the present invention for use with a vehicle seat 21. Heat shield device 25 comprises a pouch 22, an upper portion 23 and a lower portion 24 of a light/heat reflective material. Pouch 22 rests over the top of seat 21. Bottom portion 24, top portion 23, and/or pouch 22 may include any of magets, elastic, velcro, grommets, or other securing implementations useful for attaching the heat shield device 25 to vehicle seat 21.

The description of the subject technology is provided to enable any person skilled in the art to practice the various configurations described herein. While the disclosure has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the sprit and scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the spirit and scope of the subject technology.

It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A heat shield with a pouch, comprising:
a first layer comprising a flexible, sunlight reflective material with at least one edge;
a second layer comprising a flexible, cushioning material with at least one edge; and
a flexible edging with a first tensile strength that is greater than a combined second tensile strength of each of a third tensile strength of the first layer and a fourth tensile strength of the second layer, the flexible edging fixed at a location along the at least one edge of the first layer and the at least one edge of the second layer;
wherein the first layer and the second layer are layered one atop the other such that the at least one edge of the first layer and the at least one edge of the second layer substantially adjoin, and the first layer and the second layer are fixed to each other substantially at the location of the flexible edging;
further wherein the first layer and the second layer are folded back to form the pouch.

2. A heat shield, comprising:
a first flexible layer with sunlight reflective means, the first flexible layer comprising at least one edge;
a second flexible layer with cushioning means, the second flexible layer comprising at least one edge; and
flexible edging means for providing a tensile strength that is greater than a combined tensile strength of each of a tensile strength of the first flexible layer and a tensile strength of the second flexible layer, the flexible edging means being fixed at a location along the at least one edge of the first flexible layer and the at least one edge of the second flexible layer;
wherein the first flexible layer and the second flexible layer are layered one atop the other such that the at least one edge of the first flexible layer and the at least one edge of the second flexible layer substantially adjoin, and the first flexible layer and the second flexible layer are fixed to each other substantially at the location of the flexible edging means;
further wherein the first flexible layer and the second flexible layer are folded back to form a pouch means, the pouch means functioning to hang the heat shield from an item or structure to be shielded from radiant or transmitted energy.

3. The heat shield of claim 1, wherein:
the flexible edging comprises bias tape.

4. The heat shield of claim 1, wherein:
a length of the heat shield is substantially 56 inches.

5. The heat shield of claim 4, wherein:
a width of the heat shield is substantially 21 inches.

6. The heat shield of claim 1, wherein:
the pouch is substantially 21 inches long and substantially 10 inches in depth.

7. The heat shield of claim 1, wherein:
the sunlight reflective material is a microfoil.

8. The heat shield of claim 1, wherein:
the cushioning material comprises at least one of thin foam and bubble insulation.

9. The heat shield of claim 1, comprising:
at least one of an elastic band, velcro, and grommets.

10. The heat shield of claim 1, wherein:
the first layer reflects at least a light wavelength range of between 10 nanometers and 400 nanometers.

11. The heat shield of claim 1, wherein:
the flexible edging is malleable with the human hand and is shape-retentive when bent to a certain angle.

12. The heat shield of claim 5, comprising:
an indentation in the width of the heat shield located substantially at a center length of the heat shield, comprising a distance substantially 5 inches on each side of the center length.

13. The heat shield of claim 1, wherein:
the pouch is of a size to fit over and rest upon the top of an average-sized steering wheel for an automobile.

14. The heat shield of claim 1, wherein:
the pouch is of a size to fit over and rest upon the top of an average automobile seat.

15. The heat shield of claim 1, wherein:
the flexible edging is attached to each of the first layer and the second layer with at least one of stitching and glue.

16. The heat shield claim 1, wherein:
an underside of the second layer comprises a non-slip surface.

17. The heat shield of claim 1, wherein:
at least one of the first layer and the second layer comprises a rip-stop material with interwoven threads in a cross-hatch pattern.

18. The heat shield of claim 1, comprising:
at least one magnet for securing the heat shield to a surface.

19. The heat shield of claim 1, comprising:
at least one weight sewn into the heat shield for securing the heat shield on windy days.

20. The heat shield of claim 1, wherein:
the flexible, sunlight reflective material reflects wavelengths of visible light.
